(19) United States
(12) Patent Application Publication
(10) Pub. No.: US 2009/0315857 A1
(43) Pub. Date: Dec. 24, 2009

(54) DISPLAY DEVICE WITH TOUCH PANEL

(75) Inventors: Shigeyuki NISHITANI, Mobara (JP); Hideo SATO, Hitachi (JP); Teruaki SAITO, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/485,995

(22) Filed: Jun. 17, 2009

(30) Foreign Application Priority Data
Jun. 19, 2008 (JP) 2008-160449

(51) Int. Cl. G06F 3/045; G09G 3/36

(52) U.S. Cl. 345/174; 345/211; 345/87

(57) ABSTRACT

A present display device with a touch panel includes: four detection circuits each of which is provided in one of the four corners of the transparent conductive film; and a coordinate position arithmetic circuit to which voltages detected by the four detection circuits are input. The detection circuits each include: a detection switch which supplies the position detection voltage to the corner of the transparent conductive film; and an integration circuit which integrates a current that flows in the corner of the transparent conductive film where its own detection circuit is provided after the detection switch is switched off. Based on voltages integrated by the four integration circuits, the coordinate position arithmetic circuit calculates which point on the transparent conductive film has been touched with one of a finger of an observer and a pen held by the observer.

### CROSS-REFERENCE TO RELATED APPLICATION

The present application claims priority from Japanese application JP 2008-160449 filed on Jun. 19, 2008, the content of which is hereby incorporated by reference into this application.

### BACKGROUND OF THE INVENTION

1. Field of the Invention

The present invention relates to a display device with a touch panel, and more particularly, to a display device with a touch panel that has a capacitive touch panel function and realizes a high transmittance.

2. Description of the Related Art

In recent years, a touch panel technology that supports human-conscious graphical user interfaces has played a pivotal role in prevalence of mobile equipment.

As the touch panel technology, capacitive touch panels have been known. The typical capacitive touch panel includes a touch panel substrate having a conductive coating (transparent conductive film) formed on the surface of a glass substrate. When the touch panel substrate is touched with a finger, position detection is carried out.

Also known is a liquid crystal display device with a touch panel that has the touch panel substrate attached to the surface of a liquid crystal display panel, and that performs an operation associated with a menu item designated by touching a menu screen image, which is displayed on the liquid crystal display panel, with a finger (refer to JP 2006-146895 A).

### SUMMARY OF THE INVENTION

In the liquid crystal display device with a touch panel described in JP 2006-146895 A, an alternating signal is applied to the touch panel, which is coated with a transparent conductive film, through four corners thereof. A current flowing into a finger with which the touch panel is touched is detected in order to detect coordinates. For detection of the current, a voltage developed across a resistor disposed at each of the four corners of the touch panel in order to detect a current is detected and converted into a current.

However, the liquid crystal display device with a touch panel described in JP 2006-146895 A poses problems described below.

(1) In order to preserve a current that flows into a finger with which the touch panel is touched, the transparent conductive film has to be thick in order to decrease a resistance. This degrades the transmittance of the touch panel.

(2) Four sets of a current detection circuit, a noise filter, and a sample-and-hold circuit are needed in association with the four corners of the touch panel, and hence circuitry becomes complex.

The present invention has been made in order to solve the problems underlying the related art. An object of the present invention is to provide a display device with a touch panel having a cost thereof reduced without a decrease in transmittance of light.

Of aspects of the present invention disclosed herein, the representative one is briefly mentioned as follows:

(1) A display device with a touch panel includes: a substrate which includes a planar transparent conductive film formed on an observer side thereof, the transparent conductive film being used as a transparent electrode of a capacitive touch panel, and being shaped to have four corners; four detection circuits each of which is provided in one of the four corners of the transparent conductive film to detect a voltage that is output from each corner of the transparent conductive film after a position detection voltage is supplied to the corner of the transparent conductive film; and a coordinate position arithmetic circuit to which voltages detected by the four detection circuits are input, in which each of the four detection circuits includes: a detection switch which supplies the position detection voltage to the corner of the transparent conductive film where its own detection circuit is provided; and an integration circuit which integrates a current that flows in the corner of the transparent conductive film where its own detection circuit is provided after the detection switch is switched off, and in which, based on voltages integrated by the four integration circuits, the coordinate position arithmetic circuit calculates which point on the transparent conductive film has been touched with one of a finger of an observer or a pen held by the observer.

(2) In the display device with a touch panel relating to Item (1), the detection switch of each of the four detection circuits supplies the position detection voltage a plurality of times to the corner of the transparent conductive film where its own detection circuit is provided, and the integration circuit of each of the four detection circuits outputs a voltage that is a sum of voltages obtained by integrating, a plurality of times, a current that flows in the corner of the transparent conductive film where its own detection circuit is provided, the current being one that flows after each time the position detection voltage is supplied to the corner of the transparent conductive film where its own detection circuit is provided in the course of the supplying of the position detection voltage a plurality of times.

(3) In the display device with a touch panel relating to Item (1) or (2), each of the four detection circuits includes an A/D conversion circuit connected downstream of the integration circuit.

(4) The display device with a touch panel according to any one of Items (1) to (3) is an in-plane switching (IPS) liquid crystal display device.

(5) The display device with a touch panel relating to Item (4) further includes a reverse-surface side transparent conductive film which is formed on the observer side of a liquid crystal display panel, in which the reverse-surface side transparent conductive film doubles as the transparent conductive film.

(6) The display device with a touch panel relating to Item (5) further includes a conductive polarizer which is placed on the transparent conductive film.

An effect provided by the representative one of the aspects of the present invention disclosed herein is briefly described below.

With the display device with a touch panel relating to the present invention, the transmittance of light is not decreased but the cost thereof can be reduced.

The aforementioned and other objects and novel features of the present invention are clarified through a description given herein and accompanying drawings.

### BRIEF DESCRIPTION OF THE DRAWINGS

In the accompanying drawings:

FIG. 1A and FIG. 1B are diagrams illustrating a principle of detecting a point on a touch panel in a liquid crystal display device with a touch panel according to the present invention;

FIG. 2A is a diagram illustrating a schematic structure of the touch panel in the liquid crystal display device with a touch panel according to the present invention;

FIG. 2B is a circuit diagram illustrating a structure of detection circuits of FIG. 2A;

FIG. 3 is a timing chart illustrating voltage waveforms of respective components of FIG. 2A and FIG. 2B;

FIG. 4 is a block diagram illustrating a schematic structure of a liquid crystal display device with a touch panel according to an embodiment of the present invention;

FIG. 5 is a plan view illustrating a structure of a single sub-pixel of a liquid crystal display panel according to the embodiment of the present invention; and

FIG. 6 is a sectional view illustrating a sectional structure that is taken along the line VI-VI of FIG. 5.

### DETAILED DESCRIPTION OF THE INVENTION

Referring to the drawings, an embodiment having the present invention applied to a liquid crystal display device is described below.

Incidentally, in all the drawings that are referenced in order to describe the embodiment, the same reference numeral is assigned to components sharing the same capabilities. An iterative description thereof is omitted.

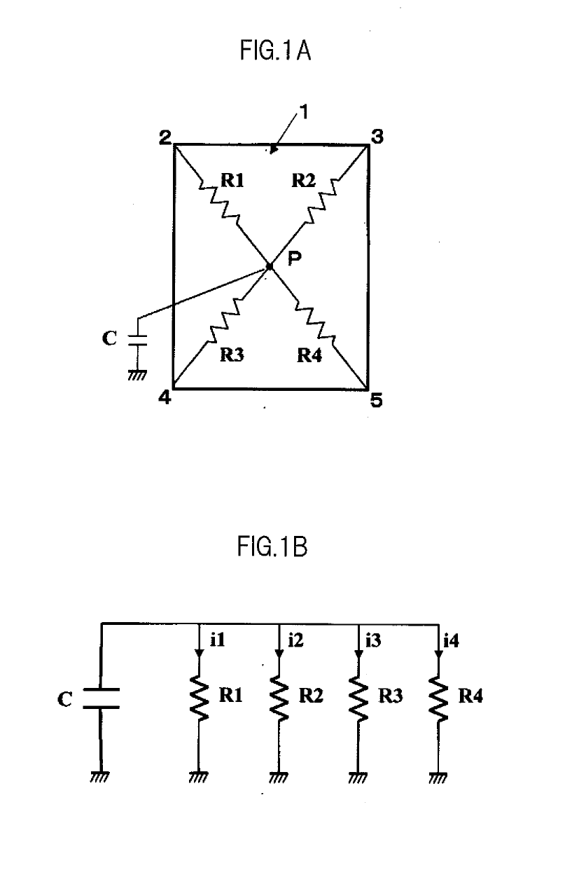

FIG. 1A and FIG. 1B are diagrams illustrating a principle of detecting a point on a touch panel in a liquid crystal display device with a touch panel according to the present invention.

In FIG. 1A, there is illustrated a touch panel 1 coated with a transparent conductive film. When a point P on the touch panel 1 is touched with an observer's finger or a stylus pen held by an observer, it means that a capacitor C is inserted between the point P on the touch panel 1 and a reference potential (GND).

In this state, a position detection voltage (initial voltage Vrst) is input in all four corners of the touch panel 1, thereby charging the finger (or the stylus pen held by the observer) which equals the capacitor C.

The voltages used to charge the capacitor C are then discharged from all the four corners of the touch panel 1. An equivalent circuit of the touch panel 1 in this state is illustrated in FIG. 1B. Currents caused to flow in the four corners of the touch panel 1 by the discharge are integrated by four integration circuits, each of which is assigned to one of the four corners of the touch panel 1.

The above-mentioned procedure is repeated a plurality of times to obtain large integration outputs. The output voltages of the four integration circuits are compared to calculate which point (coordinates) on the touch panel 1 has been touched with the observer's finger (or the stylus pen held by the observer).

In FIG. 1A and FIG. 1B, denoted by R1 is an equivalent resistor between a corner 2 of the touch panel 1 and the point P, denoted by R2 is an equivalent resistor between a corner 3 of the touch panel 1 and the point P, denoted by R3 is an equivalent resistor between a corner 4 of the touch panel 1 and the point P, and denoted by R4 is an equivalent resistor between a corner 5 of the touch panel 1 and the point P.

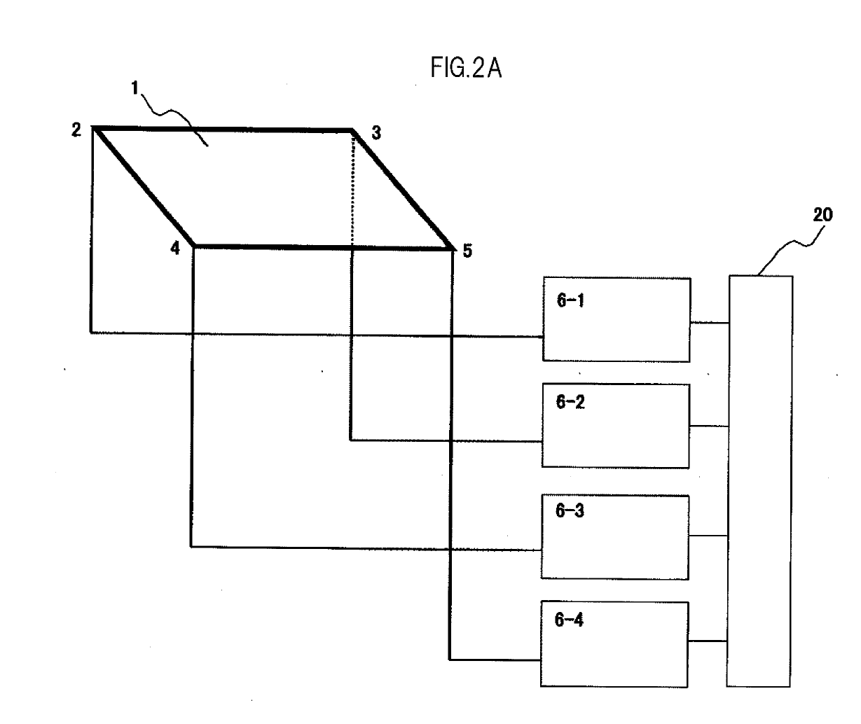

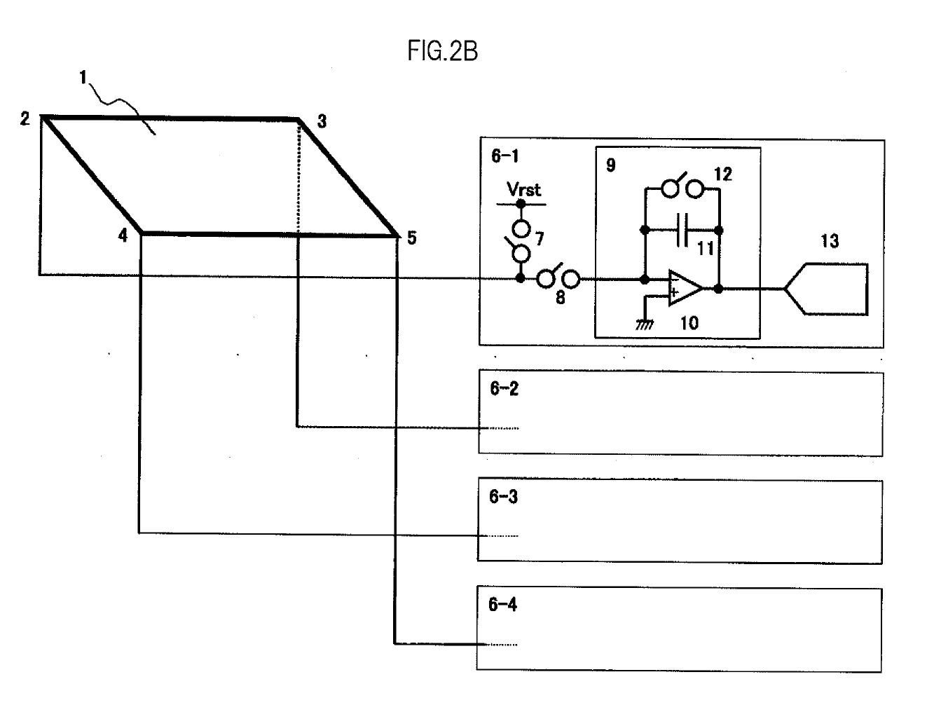

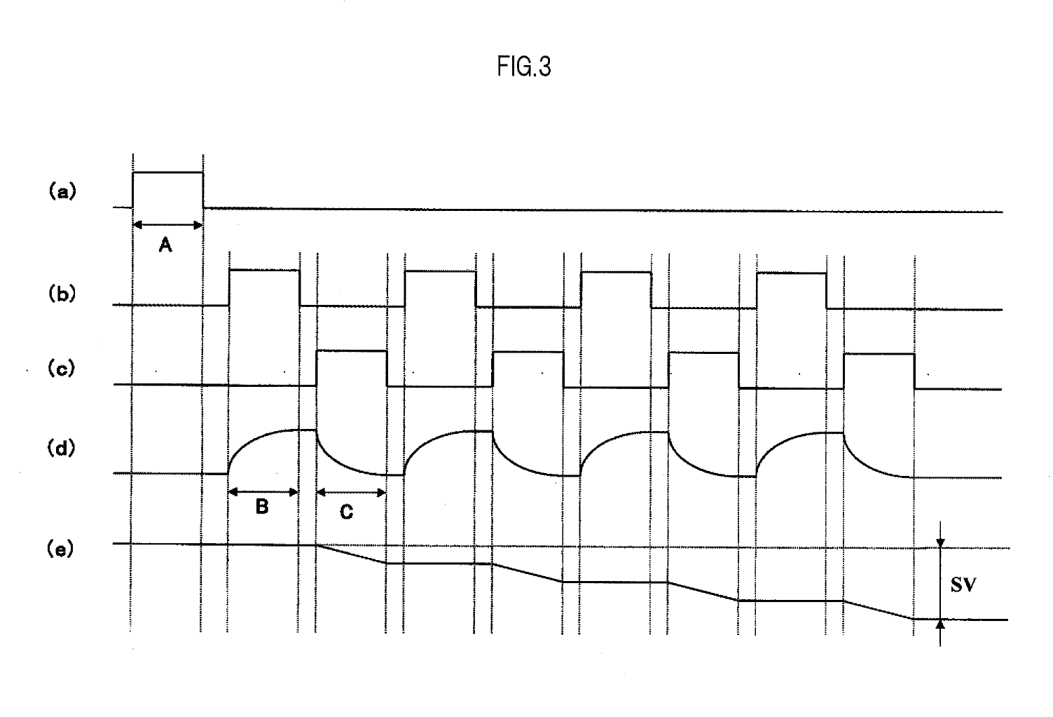

FIG. 2A is a diagram illustrating a schematic structure of a touch panel in a liquid crystal display device with a touch panel according to the embodiment of the present invention, and FIG. 2B is a circuit diagram illustrating a structure of detection circuits of FIG. 2A. FIG. 3 is a timing chart illustrating voltage waveforms of respective components of FIG. 2A and FIG. 2B.

In this embodiment, as illustrated in FIG. 2A, detection circuits 6-1, 6-2, 6-3, and 6-4 are provided in the corners 2, 3, 4, and 5 of the touch panel 1, respectively. From voltages detected by the four detection circuits (6-1, 6-2, 6-3, and 6-4), a coordinate position arithmetic circuit 20 calculates which point on the touch panel 1 has been touched with the observer's finger (or the stylus pen held by the observer).

As illustrated in FIG. 2B, the detection circuits 6-1, 6-2, 6-3, and 6-4 each includes a detection switch 7, a switch 8, an integration circuit 9, and an A/D converter 13. The integration circuit 9 includes an operational amplifier 10, a capacitor 11, and a reset switch 12.

The operation of the touch panel 1 according to this embodiment is described below.

As indicated by a waveform (a) of FIG. 3, the reset switch 12 is switched on at the start of coordinate position detection, to discharge electric charges accumulated in the capacitor 11 of the integration circuit 9 and to thereby initialize the integration circuit 9 (a period A of the waveform (a) in FIG. 3).

An observer's finger (or a stylus pen held by an observer) touches the touch panel 1, adding the capacitor C at the touched point as illustrated in FIG. 1A and FIG. 1B.

As indicated by waveforms (b) and (c) of FIG. 3, the added capacitor C is charged from the corner 2, corner 3, corner 4, and corner 5 of the touch panel 1 by switching on the detection switch 7 and switching off the switch 8 in every one of the detection circuits (6-1, 6-2, 6-3, and 6-4). This period is denoted by B of a waveform (d) in FIG. 3.

Next, as indicated by the waveforms (b) and (c) of FIG. 3, electric charges in the capacitor C are discharged from the four corners of the touch panel 1 separately by switching off the detection switch 7 and switching on the switch 8 in every one of the detection circuits (6-1, 6-2, 6-3, and 6-4). This period is denoted by C of the waveform (d) in FIG. 3.

The amount of current discharged from each of the corners 2, 3, 4, and 5 of the touch panel 1 is determined by the resistance of the resistor that is interposed between a point where the capacitor C has been added and the corner in question of the touch panel 1.

For example, the resistor between the point P where the capacitor C has been added and the corner 2 is the resistor R1, whose resistance corresponds to the distance between the point P and the corner 2. A current flowing in this corner is in inverse proportion to the resistance of the resistor R1. Similarly, the resistors between the point P and the corner 3, between the point P and the corner 4, and between the point P and the corner 5 are respectively the resistors R2, R3, and R4, whose resistances correspond respectively to the distance between the point P and the corner 3, the distance between the point P and the corner 4, and the distance between the point P and the corner 5. Currents flowing in these corners are in inverse proportion to the resistances of their respective resistors.

The point P is then identified by measuring separately the currents that are flowing in the corners 2, 3, 4, and 5 of the touch panel 1. The currents discharged from the corners 2, 3, 4, and 5 of the touch panel 1 are integrated by their respective integration circuits 9 to be converted into voltages.

The above-mentioned charging (the period B of the waveform (d) in FIG. 3) and discharging (the period C of the waveform (d) in FIG. 3) are repetitively executed to repeat the integration operation. A voltage amplitude as large as SV of a waveform (e) in FIG. 3 is thus obtained.

The voltage outputs of the integration circuits 9 are converted by the A/D converters 13 into digital data.

When one integration circuit 9 has a negative voltage output, a larger voltage output of the integration circuit 9 means a shorter distance between the point P and the relevant corner, and a smaller voltage output of the integration circuit 9 means a longer distance between the point P and the relevant corner.

Accordingly, outputs of the integration circuits 9 in the corners 2, 3, 4, and 5 indicate the respective distance relations of the corners 2, 3, 4, and 5 of the touch panel 1 with respect to the point P.

With the outputs of the integration circuits 9 converted into digital data by the A/D converters 13, the coordinate position arithmetic circuit 20 obtains through digital processing the coordinates of the point on the touch panel 1 where the observer's finger (or the stylus pen held by the observer) has touched.

Further, repeating the integration operation through repetitive charging and discharging reduces noise generated on the touch panel 1, which provides a noise-resistant touch panel. Applying the present invention to liquid crystal-, EL-, or other types of displays with an incorporated input function, in particular, makes the input function resistant to noise that are generated from the display.

As has been described, the touch panel 1 in this embodiment measures the voltage in each touch panel corner from which a pulsating voltage is supplied, and the measured voltage is determined by the resistance of a resistor which corresponds to the distance from a point on the touch panel 1 where an observer's finger (or a stylus pen held by an observer) has touched to the corner, and by the capacitance of a capacitor that the observer's finger (or a stylus pen held by an observer) creates. A transparent conductive film formed on the touch panel 1 by application can thus be made thin and high in resistance. As a result, the transmittance of the touch panel 1 is improved.

In addition, each detection circuit in this embodiment can be built from a detection switch, a switch, and an integration circuit, which makes the detection circuit structure simpler than in JP 2006-146895 A, where four sets of current detection circuit, noise filter, and sample-and-hold circuit are required.

As one of liquid crystal display devices, an in-plane switching (IPS) type liquid crystal display device is known. In the IPS type liquid crystal display device, pixel electrodes and a counter electrode are formed in the same substrate, and an electric field is applied between the pixel electrodes and a counter electrode so that liquid crystalline molecules are rotated on the substrate plane in order to control a contrast. Consequently, the IPS type liquid crystal display device has a feature that the shades of a display image are not inverted when the screen is seen obliquely.

In an IPS type liquid crystal display panel, unlike a twisted nematic (TN) type liquid crystal display panel or a vertical alignment (VA) type liquid crystal display panel, a counter electrode does not exist on a substrate on which a color filter is disposed. For reasons of minimizing display noise or the like, a reverse-surface side transparent conductive film made of, for example, ITO is formed on the substrate on which the color filter is disposed.

When the reverse-surface side transparent conductive film is used as a transparent electrode of the touch panel 1 of this embodiment, the liquid crystal display panel can be constituted without an increase in cost. Further, the transmittance of the liquid crystal display panel can be equalized to that of the conventional IPS type liquid crystal display panel.

A description is made of an example of a liquid crystal display device that uses the reverse-surface side transparent conductive film as the transparent electrode of the touch panel 1 of this embodiment.

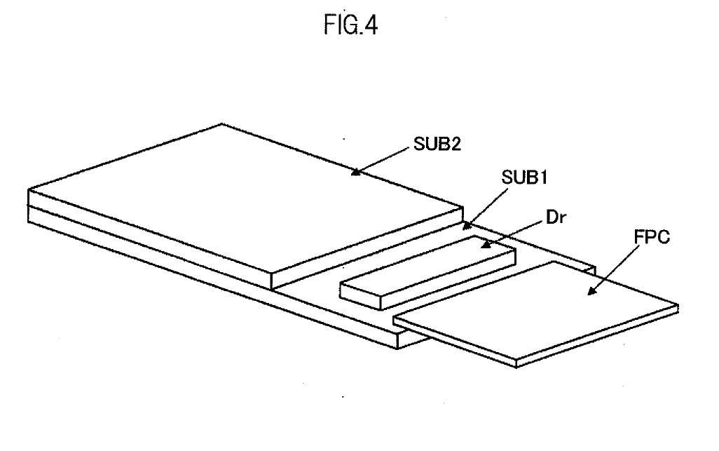

FIG. 4 is a block diagram illustrating a schematic structure of an example of a liquid crystal display device that uses the reverse-surface side transparent conductive film as the transparent electrode of the touch panel 1 of this embodiment. A liquid crystal display device with a touch panel illustrated in FIG. 4 is a compact liquid crystal display device to be adopted as a display unit of a portable cellular phone, a digital camera, etc.

A liquid crystal display panel illustrated in FIG. 4 is constructed by: laying on each other a first substrate SUB1 (also referred to as TFT substrate or active matrix substrate) in which pixel electrodes and thin-film transistors are formed, and a second substrate SUB2 (also referred to as opposite substrate), in which a color filter or the like is formed, with a predetermined space therebetween; bonding the two substrates using a seal material applied in the form of a frame near the peripheral portion of the two substrates; injecting liquid crystal into the inside of the seal material between the two substrates through a liquid crystal injection port formed in part of the seal material; sealing the liquid crystal; and bonding a polarizer to each of the external sides of the two substrates.

Thus, the liquid crystal display device illustrated in FIG. 4 is structured to have the liquid crystal sandwiched between the pair of substrates.

Moreover, the first substrate SUB1 has a larger area than the second substrate SUB2 does. A semiconductor chip Dr that realizes a driver which drives the thin-film transistors is mounted in an area on the first substrate SUB1, which is not opposed to the second substrate SUB2. A flexible printed wiring substrate (FPC) is mounted in a peripheral portion of one side of the area.

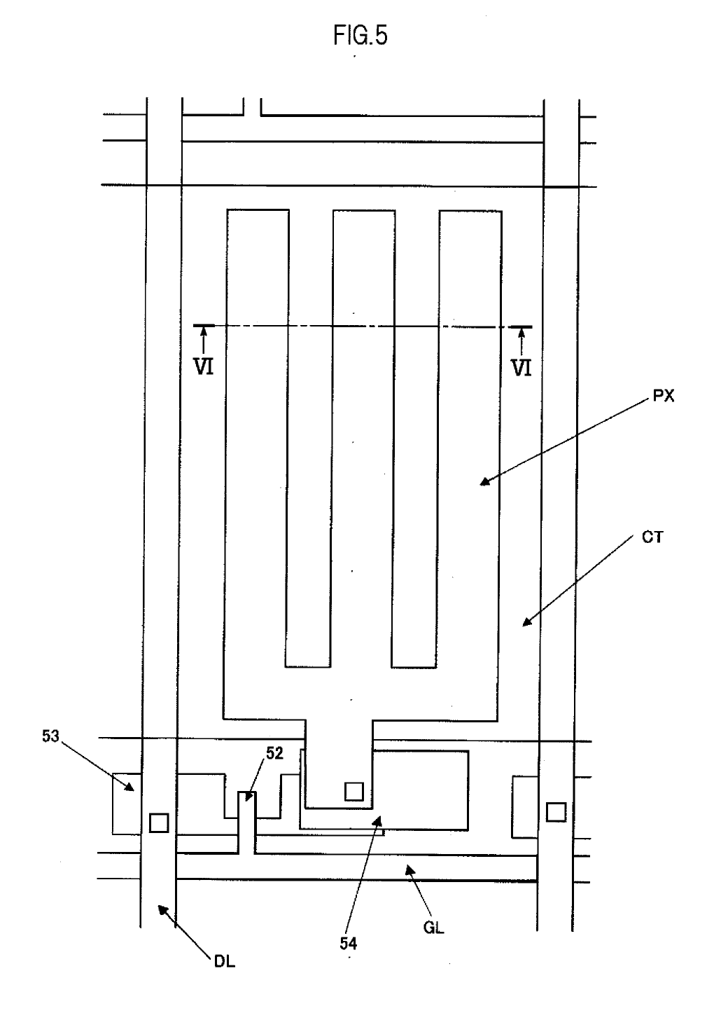

FIG. 5 is a plan view illustrating a structure of a single sub-pixel of the liquid crystal display panel illustrated in FIG. 4.

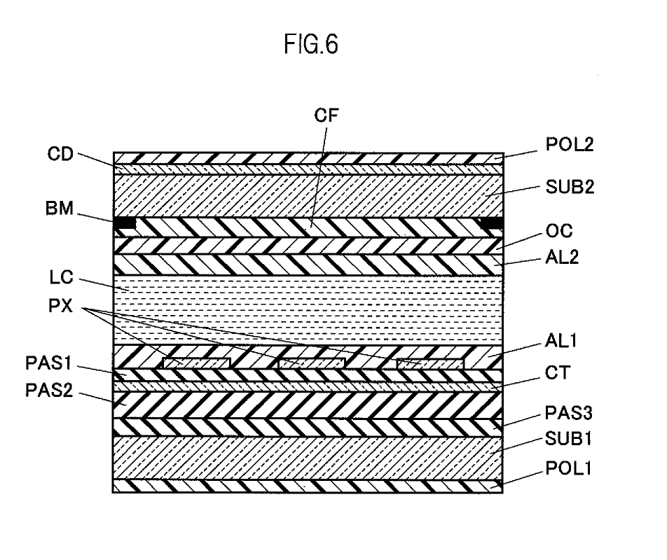

FIG. 6 is a sectional view illustrating a sectional structure that is taken along the line VI-VI illustrated in FIG. 5. Referring to FIG. 5 and FIG. 6, the structure of the liquid crystal display panel illustrated in FIG. 4 is described below.

The liquid crystal display panel of this embodiment is an IPS type liquid crystal display panel that employs a planar counter electrode, and has the main surface of the second substrate SUB2 thereof disposed on an observation side.

On a liquid crystal layer LC side of the second substrate SUB2 formed of a transparent substrate such as a glass substrate or a plastic substrate, a light shielding film BM, a color filter layer CF, an overcoat layer OC, and an alignment film AL2 are formed in the stated order from the second substrate SUB2 to the liquid crystal layer LC. Further, a reverse-surface side transparent conductive film CD and a polarizer POL2 are formed on the external side of the second substrate SUB2.

Moreover, on the liquid crystal layer LC side of the first substrate SUB1 formed of a transparent substrate such as a glass substrate or a plastic substrate, scanning lines (also referred to as gate lines) GL (not shown), an interlayer insulating film PAS3, video lines (also referred to as drain lines and source lines) DL (not shown), an interlayer insulating film PAS2, a planar counter electrode CT, an interlayer insulating film PAS1, pixel electrodes PX formed with pectinate electrodes, and an alignment film AL1 are formed in the stated order from the first substrate SUB1 to the liquid crystal layer LC. Further, a polarizer POL1 is formed on the external side of the first substrate SUB1.

Moreover, in FIG. 5, reference numeral 52 denotes a gate electrode, 53 denotes a semiconductor layer, and 54 denotes a source electrode.

In the liquid crystal display panel illustrated in FIG. 4, the reverse-surface side transparent conductive film CD is also used as a transparent electrode of a capacitive touch panel in order to realize a touch panel function. Consequently, the reverse-surface side transparent conductive film CD illustrated in FIG. 4 also serves as the transparent conductive film of the touch panel 1 illustrated in FIGS. 2A and 2B. In the structure illustrated in FIG. 6, the polarizer POL2 is disposed on the reverse-surface side transparent conductive film. When the polarizer POL2 is insulating, when an observer touches the polarizer POL2 with his/her finger, the observer's finer may not function as a capacitor. In this case, a polarizer having conductivity may be adopted as the polarizer POL2.

The detection circuits (6-1, 6-2, 6-3, and 6-4) illustrated in FIGS. 2A and 2B may be mounted to the semiconductor chip (Dr) of FIG. 4, or may be placed outside the semiconductor chip (here, on the main body side of a cellular phone).

As described above, according to the liquid crystal display device illustrated in FIG. 4, a liquid crystal display device that makes the most of the features of the IPS type liquid crystal display panel, realizes a low cost and a high transmittance, and includes a capacitive touch panel can be provided. Specifically, the reverse-surface side transparent conductive film CD is used as the transparent electrode of the capacitive touch panel, whereby the necessity of including another glass substrate (that is, touch panel substrate) is obviated. Consequently, a decrease in transmittance can be prevented. Further, an increase in cost can be suppressed.

Moreover, the liquid crystal display device illustrated in FIG. 4 need not include another glass substrate (that is, touch panel substrate), and hence the thickness of the liquid crystal display device can be decreased. Moreover, the liquid crystal display device can be made lightweight.

The present invention is not limited to the IPS type liquid crystal display panel but can be applied to the TN type liquid crystal display panel and the VA type liquid crystal display panel. However, in the case of the TN type liquid crystal display panel, the VA type liquid crystal display panel, and other liquid crystal display panels that need not have a transparent conductive film formed on the side of the second substrate SUB2 opposite to the side thereof on which liquid crystal is disposed, another transparent conductive film has to be formed.

Incidentally, the present invention is not limited to liquid crystal display devices but can be applied to all types of display devices including an organic electroluminescence (EL) display device.

While there have been described what are at present considered to be certain embodiments of the invention, it is understood that various modifications may be made thereto, and it is intended that the appended claims cover all such modifications as fall within the true spirit and scope of the invention.

What is claimed is:

1. A display device with a touch panel, comprising:
a substrate which includes a planar transparent conductive film formed on an observer side thereof, the transparent conductive film being used as a transparent electrode of a capacitive touch panel, and being shaped to have four corners;
four detection circuits each of which is provided in one of the four corners of the transparent conductive film to detect a voltage that is output from each corner of the transparent conductive film after a position detection voltage is supplied to the corner of the transparent conductive film; and
a coordinate position arithmetic circuit to which voltages detected by the four detection circuits are input,
wherein each of the four detection circuits includes:
a detection switch which supplies the position detection voltage to the corner of the transparent conductive film where its own detection circuit is provided; and
an integration circuit which integrates a current that flows in the corner of the transparent conductive film where its own detection circuit is provided after the detection switch is switched off, and
wherein, based on voltages integrated by the four integration circuits, the coordinate position arithmetic circuit calculates which point on the transparent conductive film has been touched with one of a finger of an observer or a pen held by the observer.

2. A display device with a touch panel according to claim 1,
wherein the detection switch of each of the four detection circuits supplies the position detection voltage a plurality of times to the corner of the transparent conductive film where its own detection circuit is provided, and
wherein the integration circuit of each of the four detection circuits outputs a voltage that is a sum of voltages obtained by integrating, a plurality of times, a current that flows in the corner of the transparent conductive film where its own detection circuit is provided, the current being one that flows after each time the position detection voltage is supplied to the corner of the transparent conductive film where its own detection circuit is provided in the course of the supplying of the position detection voltage a plurality of times.

3. A display device with a touch panel according to claim 1, wherein each of the four detection circuits includes an A/D conversion circuit connected downstream of the integration circuit.

4. A display device with a touch panel according to claim 1, which is an in-plane switching (IPS) liquid crystal display device.

5. A display device with a touch panel according to claim 4, further comprising a reverse-surface side transparent conductive film which is formed on the observer side of a liquid crystal display panel,
wherein the reverse-surface side transparent conductive film doubles as the transparent conductive film.

6. A display device with a touch panel according to claim 5, further comprising a conductive polarizer which is placed on the transparent conductive film.
